(19) United States
(12) Patent Application Publication
(10) Pub. No.: US 2015/0013835 A1
(43) Pub. Date: Jan. 15, 2015

(54) EXTRACTION DEVICE FOR A SINGLE EXTRACTION OF A MEDICAMENT FROM A CONTAINER

(71) Applicant: SANOFI-AVENTIS DEUTSCHLAND GMBH, Frankfurt am Main (DE)

(72) Inventor: Claus Cordes, Frankfurt (DE)

(21) Appl. No.: 14/377,525

(22) PCT Filed: Feb. 27, 2013
(86) PCT No.: PCT/EP2013/053852

§ 371 Date: Aug. 8, 2014

(30) Foreign Application Priority Data
Feb. 29, 2012 (EP) 12157425.5

(51) Int. Cl. A61J 1/20; B65B 3/00

(52) U.S. Cl. CPC A61J 1/2096; B65B 3/003; A61J 2001/201; A61J 2001/2065
USPC 141/18

(57) ABSTRACT

An extraction device and an extraction kit for one-time extracting a medicament from a container is presented where the extraction device has a housing adapted to non-releasably engage with the container and comprising an axially elongated receptacle, wherein the receptacle is adapted to axially guide a drug delivery device and a piercing member to a distal stop position for penetrating a seal of the container. The device and kit also have at least one fixing member to keep the piercing member in the distal stop position and to support a non-reversible disconnection of the drug delivery device from the piercing member.

### CROSS REFERENCE TO RELATED APPLICATIONS

The present application is a U.S. National Phase Application pursuant to 35 U.S.C. §371 of International Application No. PCT/EP2013/053852 filed Feb. 27, 2013, which claims priority to European Patent Application No. 12157425.5 filed Feb. 29, 2012. The entire disclosure contents of these applications are herewith incorporated by reference into the present application.

### TECHNICAL FIELD

The present invention relates to extraction devices and in particular to an extraction device adapted to inhibit multiple withdrawal of a medicament from a container, such like a vial, carpule or ampoule.

### BACKGROUND

Various medicaments are provided in a liquid form or have to be prepared as a liquid solution or liquid emulsion prior to be administered to a patient, e.g. by way of injection.

Liquid medicaments are typically provided in vitreous containers or bottles, such like vials, carpules, ampoules or cartridges. Such containers are adapted to store liquid medicaments but also lyophilized pharmaceutical product. Medicaments provided in such type of containers are to be withdrawn or extracted therefrom, e.g. by means of a drug delivery device, e.g. comprising a piercing element, by way of which a piercable seal of the container can be penetrated to withdraw a predefined amount of the medicament from the container and to fill the drug delivery device, e.g. a conventional syringe.

There also exist particular spike devices having a piercing element to penetrate a seal of the container and further having a connector allowing to connect a body of a syringe or some other kind of drug delivery device thereto.

Since the amount of a medicament to be administered to a patient may strongly vary on the patient's physiological constitution, the total amount of a dose of a medicament to be injected may strongly vary. In particular, for rather small and lightweight patients, less than half of the medicament provided in a container might be sufficient for a particular health-care treatment. After injecting the medicament, the residual amount of the medicament still provided in the container may therefore be used for other patients in an unjustified way.

However, multiple use of such medicament container and multiple withdrawal of a medicament therefrom should be avoided for reasons of patient safety. Once, a seal of the container has been penetrated or broken, the medicament contained therein may become subject to premature aging which may have a negative impact on the effectiveness of the medicament and its physiological tolerability.

It is therefore an object of the present invention to provide an extraction device and an extraction kit for inhibiting multiple extraction of a medicament from a particular container. The extraction device should be easy and intuitive to use and should be producible with low or reasonable cost-effort.

### SUMMARY

In a first aspect, an extraction device for one-time extracting a medicament from a container is provided. The extraction device comprises a housing, preferably of tubular shape, being adapted to non-releasably engage with the container. The housing further comprises an axially elongated receptacle, which in case of a tubular-shaped housing extends along the cylinder axis of the housing.

The receptacle is further adapted to axially guide a drug delivery device and a piercing member to a distal stop position for penetrating a seal of the container non-releasably connected with the housing and its receptacle. The extraction device further comprises at least one fixing member to keep the piercing member in the distal stop position and to support a non-reversible disconnection of the drug delivery device from the piercing member. The receptacle typically comprises a cupped-geometry and may have a removable or at least pivot mounted lid to cover a proximal receiving portion thereof.

The receptacle is particularly adapted to non-releasably engage or to non-releasably connect with the container. For this purpose the receptacle may comprise a positive locking means, such like a snap-fit feature and/or a frictionally engaging means, such like a clamping connector or a respective fastening member. The receptacle and/or its fastening member is preferably operable to engage with a corresponding fastening structure, e.g. with a stepped-down neck portion of the container in such a way, that a separation of container and receptacle is only possible through a destruction of either container or receptacle.

With a distal end, the housing is non-releasably engageable with the container. The axial length and radial diameter of the receptacle is chosen such, that a user is substantially hindered from entering the receptacle for not getting direct access to a seal of the container. Hence, by means of the axially elongated receptacle, direct access to a seal of the container is no longer given and can only be attained by inserting a piercing member of appropriate size into the housing's receptacle.

The receptacle of the extraction device defines a distal stop position for the piercing member. Upon reaching the distal stop position, the piercing member typically pierces a penetrable seal of the container and establishes a fluid-transferring connection to a drug delivery device. In particular, the receptacle is adapted to axially guide both, the drug delivery device and the piercing member interconnected therewith. The receptacle of the extraction device provides a combined distally directed axial displacement of drug delivery device and piercing member relative to the receptacle until a distal stop position have been reached. Once, the stop position has been reached, in which the piercing member may establish a fluid-transferring interconnection between an inside volume of the container and the drug delivery device, filling of the drug delivery device, e.g. a syringe, with the medicament can take place.

Thereafter, the fixing member of the extraction device serves to keep the piercing member in the distal stop position and further supports to non-reversibly disconnect the drug delivery device and the piercing member. This way, the drug delivery device can be removed from the receptacle while the piercing member remains in the distal stop position. Once, the drug delivery device has been separated from the piercing member and/or has been removed from the receptacle, a reconnection of piercing member and drug delivery device is effectively inhibited so that a repeated withdrawal of the medicament from the container cannot take place any longer.

In particular, the fixing member retains and keeps the piercing member in the receptacle in such a way that a drug delivery device removed and disconnected from the piercing member is effectively hindered to re-enter the receptacle and/or to become re-connected to the piercing member in a fluid-transferring way.

Since the housing and the receptacle of the extraction device are non-releasably engaged with the withdrawing end of the container, any further access to the inner volume of the container is no longer given. Consequently, after an initial and single withdrawal of the medicament from the container, the container with the extraction device mounted thereon becomes useless and has to be discarded. This way, multiple withdrawal of a medicament from the container can be effectively inhibited and patient safety can be increased accordingly.

In a preferred embodiment, the fixing member radially inwardly protrudes from an inner sidewall of the receptacle. The fixing member may comprise a radially inwardly extending protrusion adapted to engage with the piercing member. In particular, the fixing member may provide frictional and/or positive engagement with the piercing member, wherein an engaging configuration is to be established when the piercing member reaches the distal stop position. Typically, the fixing member is arranged in close proximity to a distal end of the receptacle of the extraction device in order to firmly fix the piercing member in its distal stop position inside the receptacle.

The radial diameter of the piercing member is preferably adjusted to the inner diameter of the receptacle. Furthermore, the radial extension of the at least one fixing member is preferably larger than the difference between the inner diameter of the receptacle and the outer diameter of the piercing member. Additionally, the at least one fixing member may comprise a variety of different geometric shapes. For instance, the fixing member may comprise a barbed hook-like shape allowing to displace the piercing member into its distal stop position but effectively preventing the piercing member to be displaced in an opposite, proximal direction.

It is of particular benefit, when there are several fixing members regularly arranged along the inner circumference of the receptacle. This way, the piercing member can be kept in position by a plurality of e.g. circumferentially equidistantly positioned fixing members, by way of which a tilting of the piercing member with respect to the elongated receptacle can be effectively prevented.

In a further preferred embodiment, the receptacle comprises a bottom wall at its distal end that provides a distal abutment face for the piercing member. Hence, the bottom wall defines the distal stop position for the piercing member. Preferably, the at least one fixing member is arranged at the inner sidewall of the receptacle at an axial distance which is substantially equal to or slightly larger than the axial dimension of the piercing member's component e.g. a flange portion that corresponds and interacts with the inner sidewall of the receptacle.

The bottom wall of the extraction device further comprises a through opening to receive a neck portion of the container and/or to receive a piercing element of the piercing member, which may protrude from a flange portion of the piercing member in distal direction. Typically, with a tubular shaped receptacle, the through opening is located in a central portion of the bottom wall. By means of the through opening, the piercing element of the piercing member may protrude in distal direction from the bottom wall of the extraction device, thereby penetrating the seal of the container and entering the inner volume of the container, to provide access to the medicament provided therein.

In another embodiment, the extraction device further comprises a tubular-shaped fastening member protruding from the bottom wall in distal direction. The fastening member is particularly adapted to receive the stepped-down neck portion of the container in order to provide a rigid, firm and secure interconnection between the extraction device and the container. The fastening member protruding from the bottom wall of the extraction device comprises at least one interlock member to frictionally and/or to positively engage with the neck portion of the container in a non-releasable way.

When provided as a vial for instance, the container comprises a stepped-down neck portion at one end further having a radially widened head providing an undercutting to fix a crimped cap on the head as well as providing an undercutting to engage with the at least one interlock member of the extraction device's fastening member. The fastening member may comprise one or several barbed hooks that may non-releasably engage with the head or neck portion of the container.

Instead of a distally extending fastening member it is also conceivable that the extraction device comprises a hollow and tubular shaft extending in proximal direction from a distal end of the extraction device. Such a shaft may be correspondingly adapted to non-releasably engage with a neck- and head-portion of e.g. a vitreous container.

In a further preferred embodiment, the extraction device comprises at least one reuse preventer to inhibit re-establishment of a fluid-transferring connection between the drug delivery device and the piercing member once the drug delivery device has been removed from the receptacle of the extraction device. The reuse preventer may serve as an active means to inhibit re-connection of the drug delivery device and the piercing member. Such a reuse preventer is of particular benefit when the drug delivery device and the piercing member are originally interconnected by means of standard connectors, such like male and female LUER connectors. Typically, such a reuse preventer may effectively inhibit to re-insert the drug delivery device into the housing or may effectively inhibit to re-connect the drug delivery device with the piercing member, which remains in the housing after the single and initial withdrawal of the medicament from the container took place.

In a preferred embodiment, the reuse preventer comprises at least one bendable or flexible deformable and/or pivotable flap portion attached to an inner sidewall of the receptacle of the extraction device. The at least one flap portion is transferable into a reuse preventing configuration, in which it radially extends across the inner diameter of the receptacle. Preferably, the elongation of the flap portion is substantially larger than the inner diameter of the receptacle. This way, the flap portion may arrive in a tilted or slanted orientation with respect to the longitudinal axis of the housing, thereby effectively inhibiting and blocking an eventual repeated insertion of the drug delivery device into the receptacle. Radially inwardly directed bending or pivoting of the at least one flap portion may be induced or triggered by the initial insertion and/or withdrawal of the drug delivery device into or from the receptacle.

It is of particular benefit, when the extraction device comprises at least two reuse preventers that comprise at least two flap portions being regularly arranged along the inner circumference of the receptacle. It is of particular benefit, to provide at least three, four or even more flap portions being separated in tangential or circumferential direction by 120° or 90°, respectively. The reuse preventers may either comprise a plastic or metallic material and may automatically transfer into the reuse preventing configuration as soon as the drug delivery device has removed from the receptacle. The plurality of flap portions of the reuse preventers may be arranged in a common lateral plane extending substantially perpendicular to the longitudinal axis of the housing. However, in order to provide a well-defined transfer into the reuse preventing configuration, it is also conceivable, that the various flap portions either comprise varying geometric dimensions and/or that the flap portions are arranged in different axial positions at the inner sidewall of the receptacle.

In a further preferred embodiment, the at least one flap portion of the at least one reuse preventer is pre-tensioned radially inwardly in an initial configuration and is further held against the inner sidewall in said initial configuration by means of an annular fixing member being slidably displaceable in distal direction with respect to the receptacle by means of the piercing member. The annular fixing member may comprise an annular shape that substantially matches with the inner diameter of the receptacle. This way, the annular fixing member may serve to clamp a proximal end of the flap portion to the sidewall of the receptacle in a configuration in which the flap portion extends substantially parallel to the longitudinal axis of the housing, in particular of its sidewall.

When providing the piercing member with a radially extending flange portion, the annular fixing member is pushed by the flange portion in distal direction during insertion of the piercing member into the receptacle. This way, the flap portion becomes effectively released. When the piercing member is pre-assembled with the drug delivery device, a radially inwardly directed flapping of the flap portions is still effectively prevented by the drug delivery device entering the free space between the at least one pre-tensioned flap portion and an oppositely located sidewall portion. It is only upon removal of the drug delivery device, that the pre-tensioned flap portion gets free to pivot or to bend radially inwardly so as to block repeated access to the piercing member located underneath.

In a further preferred embodiment, the bottom wall comprises an annular recess which corresponds to the geometric shape of the annular fixing member and which is therefore adapted to receive the annular fixing member, especially when the piercing member reaches its distal stop position inside the receptacle.

By providing an annular recess in the bottom wall of the receptacle, a well defined mutual abutment of piercing member and the bottom wall can be effectively established.

In another embodiment, the reuse preventer is of L-shaped geometry and comprises at least one radially inwardly extending flap portion at a distal end thereof in an initial configuration. This radially inwardly extending flap portion is adapted to engage with the piercing member upon insertion thereof into the receptacle. In particular, the radially inwardly extending flap portion may serve as a driver when getting in axial abutment with e.g. a distal end face or a flange portion of the piercing member. When the piercing member hits the inwardly extending flap portion during its distally directed insertion into the receptacle, the radially inwardly extending flap portion may become subject to a distally directed bending and/or a distally directed pivoting thereby inducing a radially inwardly directed torque to a proximally located and axially extending flap portion which is integrally formed with the radially inwardly extending flap portion.

The L-shaped reuse preventer is preferably pivot-mounted with a pivot axis or fulcrum located near a transitional portion of radially and axially extending flap portions. During distally directed displacement of the piercing member inter-engaging with the reuse preventer, the initially radially inwardly extending flap portion is bended or pivoted by about 90° and may then extend in distal direction, thereby inducing a radially inwardly directed bending or pivoting of the initially axially extending flap portion, which may then effectively block access to the piercing member located underneath.

Here it is a further benefit and according to another embodiment, when the at least one radially inwardly extending flap portion of the reuse preventer serves as the fixing member to frictionally engage with the piercing member when reaching the distal stop position. Hence, thickness of the initially radially inwardly extending flap portion and/or radial position thereof may be designed and adapted to provide sufficient friction or a kind of clamping when the piercing member is pushed towards its distal stop position. Also here, it is of particular benefit, that the initially L-shaped reuse preventer is flexible and elastically deformable so as to allow withdrawal of the drug delivery device even when the reuse preventer has been activated by insertion of the piercing member.

In a further but independent aspect, the invention also relates to an extraction kit for one-time extracting or withdrawing a medicament from a container. The kit comprises an extraction device as described above and a piercing member slidably insertable into the receptacle of said extraction device. The piercing member comprises a piercing element to pierce a seal of the container non-releasably engageable with the extraction device. Furthermore, the extraction kit comprises a drug delivery device to releasably interconnect with a proximal portion of the piercing member. The piercing member is geometrically adapted to the geometry and dimensions of the receptacle of the extraction device.

In a preferred embodiment, the piercing member comprises a radially extending flange portion to interact with the at least one radially inwardly extending fixing member of the extraction device. The piercing member, which may resemble a conventional spike device, comprises a flange portion which substantially fills the inner diameter and cross section of the receptacle. On the one hand, the flange portion provides a guiding of the piercing member through the elongated receptacle of the housing. Hence, the radially extending flange portion provides a precise guiding and alignment of the piercing element so that a seal of the container non-releasably engaged with the extraction device can be precisely hit.

On the other hand, the flange portion engages with the radially inwardly protruding fixing members of the receptacle thereby preventing a proximally directed removal of the piercing member once it has reached a distal stop position. Additionally, the radially extending flange portion may interact with bendable and/or pivotable flap portions of an active reuse preventer of the extraction device by way of which a repeated access to the piercing member can be effectively inhibited once the drug delivery device has been disconnected there from and has been removed from the receptacle in proximal direction.

In a further preferred embodiment, the piercing member of the extraction kit is pre-assembled with the drug delivery device. This way, insertion of the piercing member into the elongated receptacle can be conducted by way of the drug delivery device, which may at least partially protrude in proximal direction from the receptacle when the piercing member reaches its distal stop position.

In a further aspect, the drug delivery device and the piercing member are disconnectable by means of a fluid transferring connector and/or by means of a fluid-transferring predetermined breaking structure. In effect, the drug delivery device, e.g. a syringe and the piercing member can be integrally formed and may be inserted into the receptacle of the extraction device in a single step. When applying a proximally directed withdrawal force to the drug delivery device relative to the extraction device, the predetermined breaking structure may become subject to fracture thereby releasing the drug delivery device for removing the same from the receptacle while the piercing member remains fixed in the distal stop position by means of the at least one fixing member of the extraction device.

Here, the predetermined breaking structure may serve as a reuse preventer, especially when the part of the predetermined breaking structure that remains at a proximal portion of the piercing member does not allow for a repeated connection with a drug delivery device. The other portion of the predetermined breaking structure, which remains with the drug delivery device may however comprise a well-defined connector, such like male and/or female LUER connectors that easily allow provide to connect the drug delivery device to some kind of drug receiving component featuring a corresponding connector.

In a further preferred embodiment, the extraction kit also comprises a container, at least partially filled with the medicament and being at least pre-assembled with the extraction device in a non-releasable way. This embodiment is particularly useful since it requires to make use of the piercing member to gain accesses to the inner volume of the container.

In another preferred embodiment it is also conceivable to pre-assemble the piercing member inside the receptacle of the extraction device, which may be provided as a separate piece or which may be also pre-assembled with the at least partially filled container. Additionally, it is also conceivable, that the entire extraction kit comprising a container, an extraction device, a piercing member and a drug delivery device is entirely pre-assembled, so that a user may only have to displace the drug delivery device together with the piercing member into their distal stop position relative to the extraction device without taking any further steps of preparing the extraction kit.

The term “drug” or “medicament”, as used herein, means a pharmaceutical formulation containing at least one pharmaceutically active compound,

wherein in one embodiment the pharmaceutically active compound has a molecular weight up to 1500 Da and/or is a peptide, a protein, a polysaccharide, a vaccine, a DNA, a RNA, an enzyme, an antibody or a fragment thereof, a hormone or an oligonucleotide, or a mixture of the above-mentioned pharmaceutically active compound,

wherein in a further embodiment the pharmaceutically active compound is useful for the treatment and/or prophylaxis of diabetes mellitus or complications associated with diabetes mellitus such as diabetic retinopathy, thromboembolism disorders such as deep vein or pulmonary thromboembolism, acute coronary syndrome (ACS), angina, myocardial infarction, cancer, macular degeneration, inflammation, hay fever, atherosclerosis and/or rheumatoid arthritis,

wherein in a further embodiment the pharmaceutically active compound comprises at least one peptide for the treatment and/or prophylaxis of diabetes mellitus or complications associated with diabetes mellitus such as diabetic retinopathy,

wherein in a further embodiment the pharmaceutically active compound comprises at least one human insulin or a human insulin analogue or derivative, glucagon-like peptide (GLP-1) or an analogue or derivative thereof, or exendin-3 or exendin-4 or an analogue or derivative of exendin-3 or exendin-4.

Insulin analogues are for example Gly(A21), Arg(B31), Arg(B32) human insulin; Lys(B3), Glu(B29) human insulin; Lys(B28), Pro(B29) human insulin; Asp(B28) human insulin; human insulin, wherein proline in position B28 is replaced by Asp, Lys, Leu, Val or Ala and wherein in position B29 Lys may be replaced by Pro; Ala(B26) human insulin; Des(B28-B30) human insulin; Des(B27) human insulin and Des(B30) human insulin.

Insulin derivates are for example B29-N-myristoyl-des(B30) human insulin; B29-N-palmitoyl-des(B30) human insulin; B29-N-myristoyl human insulin; B29-N-palmitoyl human insulin; B28-N-myristoyl LysB28ProB29 human insulin; B28-N-palmitoyl-LysB28ProB29 human insulin; B30-N-myristoyl-ThrB29LysB30 human insulin; B30-N-palmitoyl-ThrB29LysB30 human insulin; B29-N—(N-palmitoyl-Y-glutamyl)-des(B30) human insulin; B29-N—(N-lithocholyl-Y-glutamyl)-des(B30) human insulin; B29-N-(ω-carboxyheptadecanoyl)-des(B30) human insulin and B29-N-(ω-carboxyheptadecanoyl) human insulin.

Exendin-4 for example means Exendin-4(1-39), a peptide of the sequence H-His-Gly-Glu-Gly-Thr-Phe-Thr-Ser-Asp-Leu-Ser-Lys-Gln-Met-Glu-Glu-Glu-Ala-Val-Arg-Leu-Phe-Ile-Glu-Trp-Leu-Lys-Asn-Gly-Gly-Pro-Ser-Ser-Gly-Ala-Pro-Pro-Pro-Ser-NH2.

Exendin-4 derivatives are for example selected from the following list of compounds:

### H-(Lys)4-des Pro36, des Pro37 Exendin-4(1-39)-NH2,

### H-(Lys)5-des Pro36, des Pro37 Exendin-4(1-39)-NH2,

### des Pro36 Exendin-4(1-39),

### des Pro36 [Asp28] Exendin-4(1-39),

### des Pro36 [IsoAsp28] Exendin-4(1-39),

### des Pro36 [Met(O)14, Asp28] Exendin-4(1-39),

### des Pro36 [Met(O)14, IsoAsp28] Exendin-4(1-39),

### des Pro36 [Trp(O2)25, Asp28] Exendin-4(1-39),

### des Pro36 [Trp(O2)25, IsoAsp28] Exendin-4(1-39),

### des Pro36 [Met(O)14 Trp(O2)25, Asp28] Exendin-4(1-39),

### des Pro36 [Met(O)14 Trp(O2)25, IsoAsp28] Exendin-4(1-39); or

### des Pro36 [Asp28] Exendin-4(1-39),

### des Pro36 [IsoAsp28] Exendin-4(1-39),

### des Pro36 [Met(O)14, Asp28] Exendin-4(1-39),

### des Pro36 [Met(O)14, IsoAsp28] Exendin-4(1-39),

### des Pro36 [Trp(O2)25, Asp28] Exendin-4(1-39),

### des Pro36 [Trp(O2)25, IsoAsp28] Exendin-4(1-39),

### des Pro36 [Met(O)14 Trp(O2)25, Asp28] Exendin-4(1-39),

### des Pro36 [Met(O)14 Trp(O2)25, IsoAsp28] Exendin-4(1-39),

wherein the group -Lys6-NH2 may be bound to the C-terminus of the Exendin-4 derivative;
or an Exendin-4 derivative of the sequence

### des Pro36 Exendin-4(1-39)-Lys6-NH2 (AVE0010),

### H-(Lys)6-des Pro36 [Asp28] Exendin-4(1-39)-Lys6-NH2,

### des Asp28 Pro36, Pro37, Pro38Exendin-4(1-39)-NH2,

### H-(Lys)6-des Pro36, Pro38 [Asp28] Exendin-4(1-39)-NH2,

### H-Asn-(Glu)5des Pro36, Pro37, Pro38 [Asp28] Exendin-4(1-39)-NH2,

### des Pro36, Pro37, Pro38 [Asp28] Exendin-4(1-39)-(Lys)6-NH2,

### H-(Lys)6-des Pro36, Pro37, Pro38 [Asp28] Exendin-4(1-39)-(Lys)6-NH2,

### H-Asn-(Glu)5-des Pro36, Pro37, Pro38 [Asp28] Exendin-4(1-39)-(Lys)6-NH2,

### H-(Lys)6-des Pro36 [Trp(O2)25, Asp28] Exendin-4(1-39)-Lys6-NH2,

### H-des Asp28 Pro36, Pro37, Pro38 [Trp(O2)25] Exendin-4(1-39)-NH2,

### H-(Lys)6-des Pro36, Pro37, Pro38 [Trp(O2)25, Asp28] Exendin-4(1-39)-NH2,

### H-Asn-(Glu)5-des Pro36, Pro37, Pro38 [Trp(O2)25, Asp28] Exendin-4(1-39)-NH2,

### des Pro36, Pro37, Pro38[Trp(O2)25, Asp28] Exendin-4(1-39)-(Lys)6-NH2,

### H-(Lys)6-des Pro36, Pro37, Pro38 [Trp(O2)25, Asp28] Exendin-4(1-39)-(Lys)6-NH2,

### H-Asn-(Glu)5-des Pro36, Pro37, Pro38 [Trp(O2)25, Asp28] Exendin-4(1-39)-(Lys)6-NH2,

### H-(Lys)6-des Pro36 [Met(O)14, Asp28] Exendin-4(1-39)-Lys6-NH2,

### des Met(O)14 Asp28 Pro36, Pro37, Pro38 Exendin-4(1-39)-NH2,

H-(Lys)6-desPro36, Pro37, Pro38 [Met(O)14, Asp28] Exendin-4(1-39)-NH2,

### H-Asn-(Glu)5-des Pro36, Pro37, Pro38 [Met(O)14, Asp28] Exendin-4(1-39)-NH2,

### des Pro36, Pro37, Pro38 [Met(O)14, Asp28] Exendin-4(1-39)-(Lys)6-NH2,

### H-(Lys)6-des Pro36, Pro37, Pro38 [Met(O)14, Asp28] Exendin-4(1-39)-(Lys)6-NH2,

### H-Asn-(Glu)5 des Pro36, Pro37, Pro38 [Met(O)14, Asp28] Exendin-4(1-39)-(Lys)6-NH2,

### H-Lys6-des Pro36 [Met(O)14, Trp(O2)25, Asp28] Exendin-4(1-39)-Lys6-NH2,

### H-des Asp28 Pro36, Pro37, Pro38 [Met(O)14, Trp(O2)25] Exendin-4(1-39)-NH2,

### H-(Lys)6-des Pro36, Pro37, Pro38 [Met(O)14, Asp28] Exendin-4(1-39)-NH2,

### H-Asn-(Glu)5-des Pro36, Pro37, Pro38 [Met(O)14, Trp(O2)25, Asp28] Exendin-4(1-39)-NH2,

### des Pro36, Pro37, Pro38 [Met(O)14, Trp(O2)25, Asp28] Exendin-4(1-39)-(Lys)6-NH2,

### H-(Lys)6-des Pro36, Pro37, Pro38 [Met(O)14, Trp(O2)25, Asp28] Exendin-4(S1-39)-(Lys)6-NH2,

### H-Asn-(Glu)5-des Pro36, Pro37, Pro38 [Met(O)14, Trp(O2)25, Asp28] Exendin-4(1-39)-(Lys)6-NH2;

or a pharmaceutically acceptable salt or solvate of any one of the afore-mentioned Exendin-4 derivative.

Hormones are for example hypophysis hormones or hypothalamus hormones or regulatory active peptides and their antagonists as listed in Rote Liste, ed. 2008, Chapter 50, such as Gonadotropine (Follitropin, Lutropin, Choriongonadotropin, Menotropin), Somatropine (Somatropin), Desmopressin, Terlipressin, Gonadorelin, Triptorelin, Leuprorelin, Buserelin, Nafarelin, Goserelin.

A polysaccharide is for example a glucosaminoglycane, a hyaluronic acid, a heparin, a low molecular weight heparin or an ultra low molecular weight heparin or a derivative thereof, or a sulphated, e.g. a poly-sulphated form of the above-mentioned polysaccharides, and/or a pharmaceutically acceptable salt thereof. An example of a pharmaceutically acceptable salt of a poly-sulphated low molecular weight heparin is enoxaparin sodium.

Antibodies are globular plasma proteins (˜150 kDa) that are also known as immunoglobulins which share a basic structure. As they have sugar chains added to amino acid residues, they are glycoproteins. The basic functional unit of each antibody is an immunoglobulin (Ig) monomer (containing only one Ig unit); secreted antibodies can also be dimeric with two Ig units as with IgA, tetrameric with four Ig units like teleost fish IgM, or pentameric with five Ig units, like mammalian IgM.

The Ig monomer is a “Y”-shaped molecule that consists of four polypeptide chains; two identical heavy chains and two identical light chains connected by disulfide bonds between cysteine residues. Each heavy chain is about 440 amino acids long; each light chain is about 220 amino acids long. Heavy and light chains each contain intrachain disulfide bonds which stabilize their folding. Each chain is composed of structural domains called Ig domains. These domains contain about 70-110 amino acids and are classified into different categories (for example, variable or V, and constant or C) according to their size and function. They have a characteristic immunoglobulin fold in which two β sheets create a “sandwich” shape, held together by interactions between conserved cysteines and other charged amino acids.

There are five types of mammalian Ig heavy chain denoted by α, δ, ε, γ, and μ. The type of heavy chain present defines the isotype of antibody; these chains are found in IgA, IgD, IgE, IgG, and IgM antibodies, respectively.

Distinct heavy chains differ in size and composition; α and γ contain approximately 450 amino acids and δ approximately 500 amino acids, while μ and ε have approximately 550 amino acids. Each heavy chain has two regions, the constant region (C_{H}) and the variable region (V_{H}). In one species, the constant region is essentially identical in all antibodies of the same isotype, but differs in antibodies of different isotypes. Heavy chains γ, α and δ have a constant region composed of three tandem Ig domains, and a hinge region for added flexibility; heavy chains μ and ε have a constant region composed of four immunoglobulin domains. The variable region of the heavy chain differs in antibodies produced by different B cells, but is the same for all antibodies produced by a single B cell or B cell clone. The variable region of each heavy chain is approximately 110 amino acids long and is composed of a single Ig domain.

In mammals, there are two types of immunoglobulin light chain denoted by X and κ. A light chain has two successive domains: one constant domain (CL) and one variable domain (VL). The approximate length of a light chain is 211 to 217 amino acids. Each antibody contains two light chains that are always identical; only one type of light chain, κ or λ, is present per antibody in mammals.

Although the general structure of all antibodies is very similar, the unique property of a given antibody is determined by the variable (V) regions, as detailed above. More specifically, variable loops, three each the light (VL) and three on the heavy (VH) chain, are responsible for binding to the antigen, i.e. for its antigen specificity. These loops are referred to as the Complementarity Determining Regions (CDRs). Because CDRs from both VH and VL domains contribute to the antigen-binding site, it is the combination of the heavy and the light chains, and not either alone, that determines the final antigen specificity.

An “antibody fragment” contains at least one antigen binding fragment as defined above, and exhibits essentially the same function and specificity as the complete antibody of which the fragment is derived from. Limited proteolytic digestion with papain cleaves the Ig prototype into three fragments. Two identical amino terminal fragments, each containing one entire L chain and about half an H chain, are the antigen binding fragments (Fab). The third fragment, similar in size but containing the carboxyl terminal half of both heavy chains with their interchain disulfide bond, is the crystallizable fragment (Fc). The Fc contains carbohydrates, complement-binding, and FcR-binding sites. Limited pepsin digestion yields a single F(ab′)2 fragment containing both Fab pieces and the hinge region, including the H—H interchain disulfide bond. F(ab′)2 is divalent for antigen binding. The disulfide bond of F(ab′)2 may be cleaved in order to obtain Fab′. Moreover, the variable regions of the heavy and light chains can be fused together to form a single chain variable fragment (scFv).

Pharmaceutically acceptable salts are for example acid addition salts and basic salts. Acid addition salts are e.g. HCl or HBr salts. Basic salts are e.g. salts having a cation selected from alkali or alkaline, e.g. Na+, or K+, or Ca2+, or an ammonium ion N+(R1)(R2)(R3)(R4), wherein R1 to R4 independently of each other mean: hydrogen, an optionally substituted C1-C6-alkyl group, an optionally substituted C2-C6-alkenyl group, an optionally substituted C6-C10-aryl group, or an optionally substituted C6-C10-heteroaryl group. Further examples of pharmaceutically acceptable salts are described in “Remington's Pharmaceutical Sciences” 17. ed. Alfonso R. Gennaro (Ed.), Mark Publishing Company, Easton, Pa., U.S.A., 1985 and in Encyclopedia of Pharmaceutical Technology.

Pharmaceutically acceptable solvates are for example hydrates.

It will be further apparent to those skilled in the pertinent art that various modifications and variations can be made to the present invention without departing from the spirit and scope of the invention. Further, it is to be noted, that any reference signs used in the appended claims are not to be construed as limiting the scope of the present invention.

### BRIEF DESCRIPTION OF THE DRAWINGS

In the following preferred embodiments of the invention will be described by making reference to the drawings, in which:

FIG. 1 schematically illustrates an extraction device non-releasably engaged with a container in an initial configuration,

FIG. 2 shows the assembly according to FIG. 1 with piercing member and drug delivery device inserted into the receptacle of the extraction device and

FIG. 3 shows the configuration of the extraction device after withdrawal of the drug delivery device,

FIG. 4 shows another embodiment of the extraction device featuring L-shaped reuse preventers in an initial configuration,

FIG. 5 shows the extraction device according to FIG. 4 after insertion of the piercing member and the drug delivery device and

FIG. 6 is illustrative of the extraction device according to FIGS. 4 and 5 after removal of the drug delivery device,

FIG. 7 shows another embodiment of the extraction device prior to displace the piercing member in its distal end position,

FIG. 8 is indicative of the embodiment according to FIG. 7 when the piercing member is in its distal stop position and

FIG. 9 shows the configuration of the embodiment according to FIGS. 7 and 8 after removal of the drug delivery device.

### DETAILED DESCRIPTION

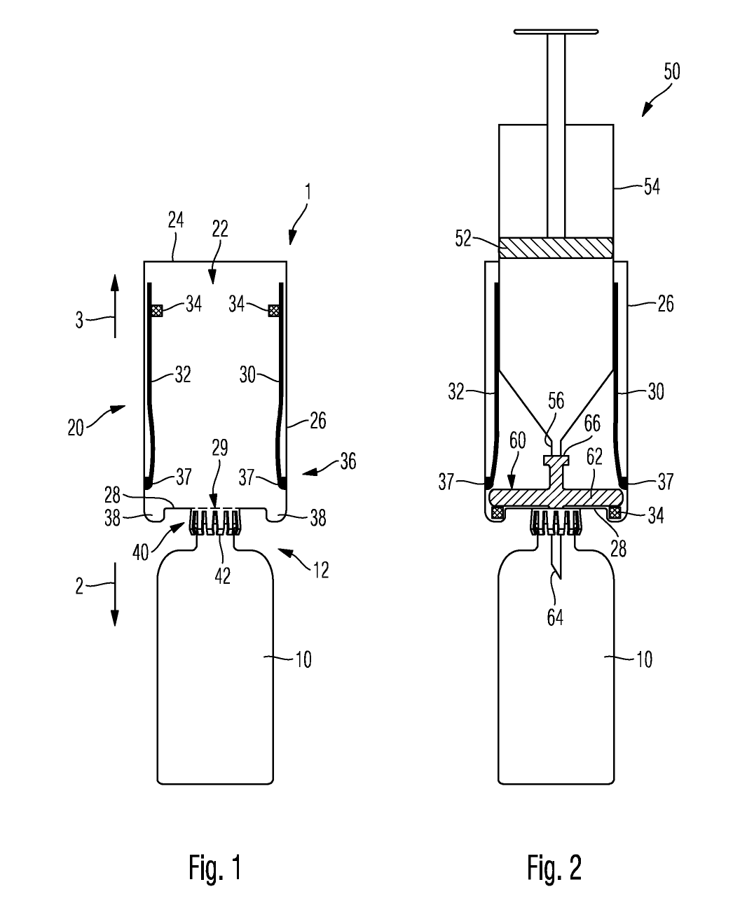

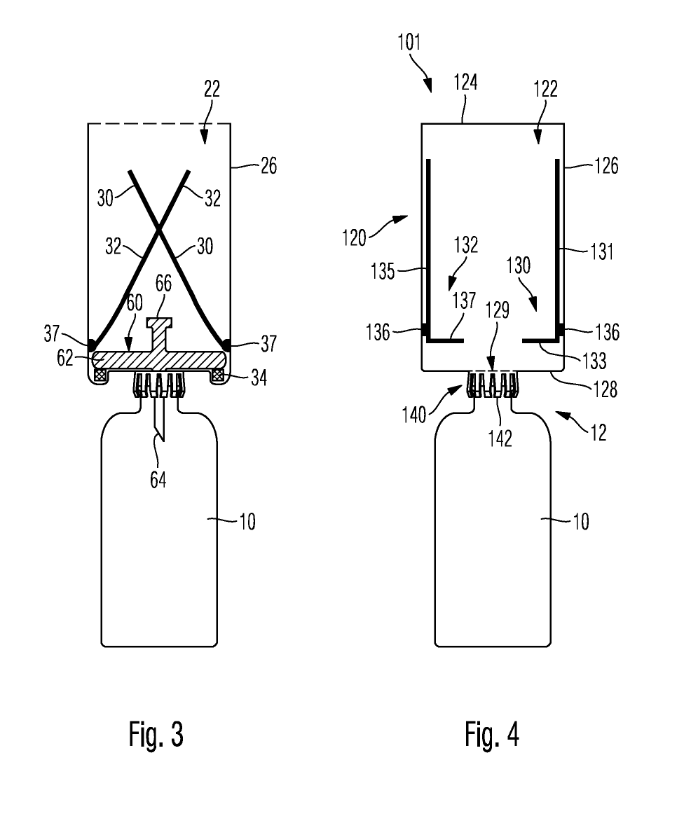

In FIGS. 1 to 3, a first embodiment of the extraction device 1 is illustrated in various configurations. The extraction device 1 as shown in FIG. 1 comprises a housing 20 of substantially tubular shape and comprising a correspondingly shaped receptacle 22. The housing 20 comprises a removable or foldable lid 24 which is to be removed or opened in order to receive a piercing member 60 together with a drug delivery device 50, as for instance shown in FIG. 2. The housing 20 further comprises a lateral but axially elongated sidewall 26 and a bottom wall 28. In the context of the present Figures, the bottom wall 28 of the housing 20 faces in distal direction 2 while the oppositely located lid 24 faces towards a proximal direction 3. Longitudinal axis of the extraction device 1 extends substantially vertically in the present set of Figures and is therefore substantially parallel to the distal direction 2 as well as to the proximal direction 3.

The extraction device 1 is non-releasably engageable with a container 10, which is typically provided as a vitreous container providing a liquid medicament in its inner volume. The container 10, which may comprise a vial, carpule or ampoule and which may be also denoted as a cartridge, comprises a stepped-down neck portion 12 towards its proximal end. Furthermore, the container 10 typically comprises a radially widened head portion, which in the present illustration is received in a distally extending and substantially tubular-shaped fastening member 40 extending from the bottom wall 28 of the housing 20. The bottom wall 28 further comprises a central through opening 29 through which a distally extending piercing element 64 of the piercing member 60 can penetrate a seal or septum of the container 10 as indicated in FIG. 2. Moreover, also the neck portion 12 and the proximal head portion of the container 10 may extend into or even through the through opening 29 of the bottom wall 28 of the housing 20 of the extraction device 1.

Near the bottom wall 28, fixing members 37 are provided at an inside facing portion of the sidewall 26 of the receptacle 22. These fixing members 37 are positively and/or frictionally engageable with a radially extending flange portion 62 of the piercing member 60 when the piercing member 60 reaches its distal stop position as shown in FIG. 2. The fixing members 37 and the flange portion 62 are designed such, that only a unidirectional motion of the piercing member 60 with regard to the fixing members 37 is allowed. Hence, once the piercing member 60 has reached the distal stop position as shown in FIG. 2, a proximally directed displacement of the piercing member 60 relative to the extraction device 1 is effectively inhibited by the mutual engagement of the fixing member 37 and the radial flange portion 62 of the piercing member 60.

Moreover, the fixing member 37 provides a fulcrum or pivot axis 36 for at least one reuse preventer 30, 32, which in the embodiment according to FIGS. 1 to 3 comprise pre-tensioned flap portions 30, 32 that are intended to bend radially inwardly with their proximally located end portions.

In the illustration according to FIG. 1, an annular fixing member 34 in form of a ring and being located between oppositely arranged flap portions 30, 32 effectively squeezes or clamps the proximal ends of the flap portion 30, 32 to the inside portion of the sidewall 26.

Since the inner diameter of the annular fixing member 34 is smaller than the outer diameter of the flange portion 62 of the piercing member 60, the annular fixing member 34 becomes subject to a distally directed displacement when the drug delivery device 50 is inserted into the receptacle 22 together with the piercing member 60. During insertion of the drug delivery device 50 and the piercing member 60, the annular fixing member 34 is pushed in distal direction 2 until it is received in a correspondingly shaped annular recess 38 at the bottom wall 28. Here, it is particularly intended, that the drug delivery device 50 and the piercing member 60 are not individually and sequentially inserted into the receptacle 22. Instead, a combined and synchronous insertion of drug delivery device 50 and piercing member 60 is intended. It is of particular benefit, when the drug delivery device 50 and piercing member 60 are pre-assembled prior to an insertion into the receptacle 22.

When pushing the annular fixing member 34 into the distally located recess 38, the radially inwardly biased or pre-tensioned flap portions 30, 32 are generally free to pivot radially inwardly. However, since the piercing member 60 is inserted into the receptacle 22 together with the drug delivery device 50, the bendable or pivotable flap portions 30, 32 are hindered to bend radially inwardly by the barrel 54 of the drug delivery device 50 extending therebetween.

Even though the annular fixing member 34 is shown in cross section as a conventional ring structure in FIGS. 1 to 3, it may also comprise radially inwardly extending recesses at its outer circumference to receive the flap portions 30, 32. This way, the annular fixing member 34 may get in direct contact with the inside facing portion of the sidewall 26. Moreover, with such radially extending recesses mating and corresponding with the position of the flap portions 30, 32, the annular fixing member 34 may be easily urged along the flap portions 30, 32 and across the fixing members 37 when displaced in distal direction.

The drug delivery device 50, which is exemplary illustrated as a syringe having a tubular barrel 54 and an axially displaceable piston slidably disposed therein, is releasably interconnected with the piercing member 60 by means of a connector 56 that corresponds with a proximally located connector 66 of the piercing member 60. In the embodiment according to FIGS. 1 to 3 it is of particular benefit, when the piercing member 60 is rotationally fixed relative to the housing 20 when reaching the distal stop position.

When the mutual interconnection of the drug delivery device 50 and the piercing member 60 is of screw type for instance, after withdrawal of a predefined amount of the medicament from the container 10 via the piercing member 60, the drug delivery device 50 and the piercing member 60 can be easily disconnected by unscrewing the drug delivery device 50 from the piercing member 60. When the piercing member 60 is for instance frictionally engaged in the distal end position, the drug delivery device 50 can be rotated relative to the housing 20 of the extraction device 1 to mutually disconnect drug delivery device 50 and piercing member 60.

Then, the drug delivery device 50 is released and can be withdrawn in proximal direction 3 from the receptacle 22. As a consequence, the previously released flap portions 30, 32 of the extraction device 1 can then bend or pivot radially inwardly, thereby blocking and inhibiting any further access to the proximal connector 66 of the piercing member 60. Since the flap portions 30, 32 mutually cross, a repeated insertion of a drug delivery device 50 into the receptacle 22 would merely lead to a further bending or pivoting of the flap portions 30, 32 until their proximal and free ends get in direct abutment with the inside wall of the receptacle 22.

Since the housing 20 is non-releasably engaged with the container 10, by means of e.g. barb-hooked interlock members 42, the extraction device 1 cannot be disassembled from the container 10 in a non-destructive way. In effect, any further and repeated access to the inside volume of the container is effectively inhibited.

With respect to FIGS. 1 to 6 it has to be noted, that the overall design of the drug delivery device 50 and the piercing member 60 may arbitrarily vary. In the embodiment shown in FIGS. 1 to 3, axial elongation of the flap portions 30, 32 should exceed the axial distance between a distally directed cylindrical portion of the barrel 54 of the drug delivery device 50 and the flange portion 62 of the piercing member 60. Otherwise, the flap portions 30, 32 may already bend or pivot radially inwardly before the cylindrical portion of the barrel 54 gets there between.

Unless otherwise described, reference numerals used in FIGS. 4 to 6 denoting similar or identical components compared to the embodiment according to FIGS. 1 to 3 are denoted with identical reference numerals increased by 100.

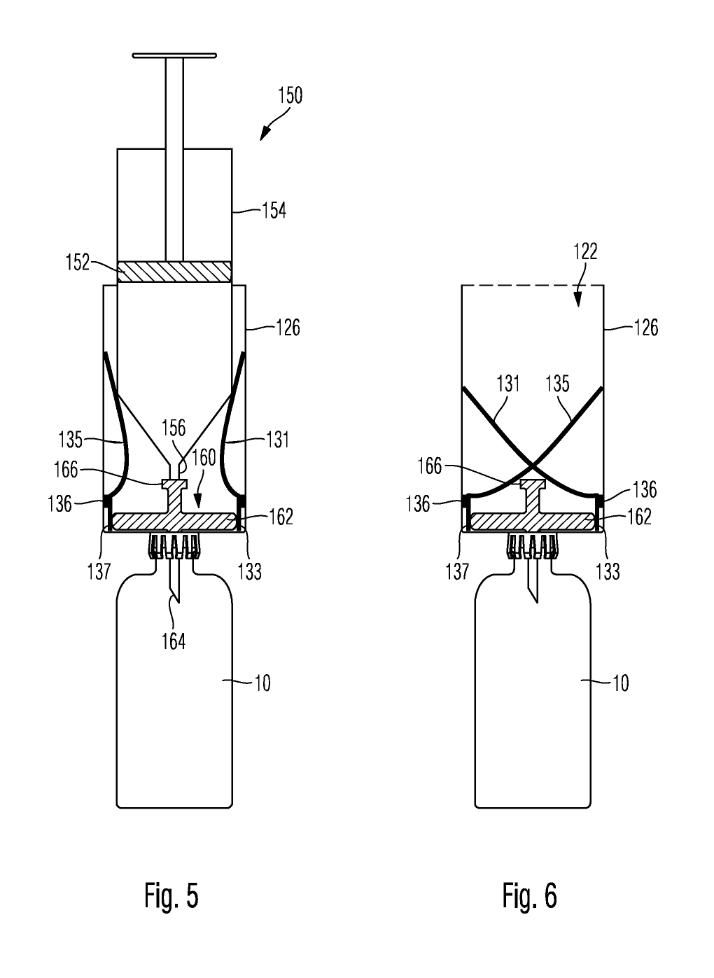

The extraction device 101 as shown in FIGS. 4 to 5 also comprises a housing 120 to be non-releasably connected with the container 10. Also here, the housing 120 comprises a distally protruding tubular-shaped fastening member 140 featuring numerous interlock members 142 to establish a positive or frictional interlock between the housing 120 and the container 10. Moreover, the receptacle 122 provided by the housing 120 is also covered by a removable lid 124 as illustrated in FIG. 4.

In contrast to the embodiment of FIGS. 1 to 3, the extraction device 101 according to FIGS. 4 to 6 comprises different fixing members 133, 137 and reuse preventers 130, 132. Instead of elastically bendable or pivotable flap portions 30, 32 as shown in FIGS. 1 to 3, the embodiment according to FIGS. 4 to 6 comprises substantially L-shaped reuse preventers 130, 132 being pivotably arranged at the inner sidewall 126 of the housing 120 with respect to a pivot axis 136. The L-shaped reuse preventers 130, 132 comprise axially and proximally extending flap portions 131, 135 as well as distally arranged radially inwardly extending flap portions 133, 137 integrally formed with the axially extending flap portions 131, 135. Here, radial extension of the distal flap portions 133, 137 is substantially equal to or is smaller than the axial distance between the bottom wall 128 and the pivot axis 136.

Upon distally directed insertion of the spike-like piercing member 160 into the receptacle 122, the radially extending flange portion 162 of the piercing member 160 engages with the radially inwardly extending distal flap portions 133, 137 and induces a distally directed pivot motion of the L-shaped reuse preventers 130, 132. Since the axially extending flap portions 131, 135 and the radially extending flap portions 133, 137 of the reuse preventers 130, 132 are integrally formed, the distally directed pivot motion of the radially extending flap portions 133, 137 induces a radially inwardly directed pivoting or bending motion of the longitudinally and initially proximally extending flap portions 131, 135.

However, since a barrel 154 of the syringe 150 has also entered the receptacle 122, the flap portions 131, 135 are hindered from completely pivoting and/or bending radially inwardly. As shown in FIG. 5, the axially extending flap portions 131, 135 abut against the outer circumference of the barrel 154 of the syringe 150.

The initially radially inwardly extending flap portions 133, 137 additionally serve as fixing members to clamp and/or to fix the piercing member 160 in its distal end position as shown in FIG. 5. Due to such clamping or frictional engagement of the piercing member 160 and the pivoted flap portions 133, 137, removal of the piercing member 160 is effectively prevented when the syringe 150 gets subject to a proximally directed withdrawal. Especially, when the syringe 150 and the piercing member 160 are coupled in a fluid transferring way, e.g. by means of mutually corresponding connectors 156, 166 it is of particular benefit, when the piercing member 160 is rotationally fixed inside the receptacle 122. Then, the syringe 150 and the piercing member 160 can be released, e.g. by way of rotating the syringe 150 relative to the housing 120.

As indicated in FIG. 5, the flap portions 131, 135 are elastically deformable, such that after withdrawal of the syringe 150 from the receptacle 122 the flap portions 131, 135 tend to relax into their initial L-shaped configuration. However, since the longitudinal or axially extending flap portions 131, 135 are longer than the inner diameter of the receptacle 122, the flap portions 131, 135 traverse the inner diameter of the receptacle 122 and abut with an opposite inner sidewall section in a tilted way. As shown in FIG. 6, the flap portions 131, 135 are biased against diametrically opposite sidewall sections and cover a proximally located connector 166 of the piercing member 160 thus making it impossible to re-connect a syringe 150 therewith.

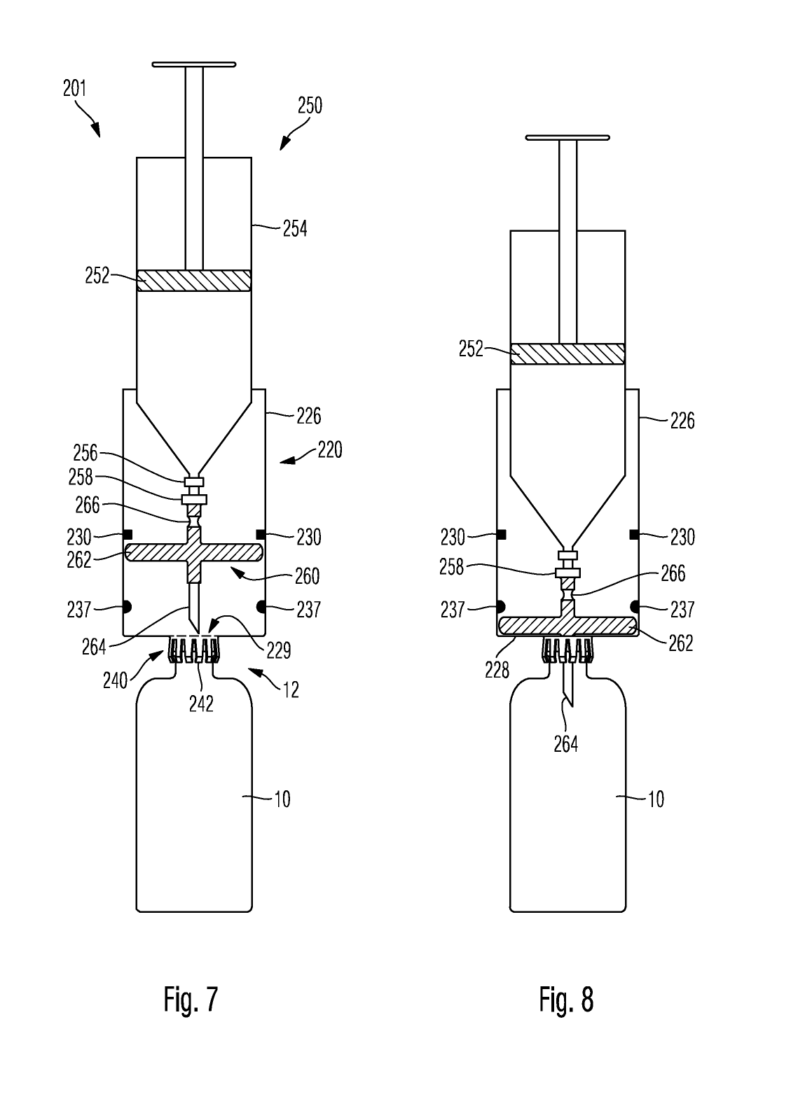

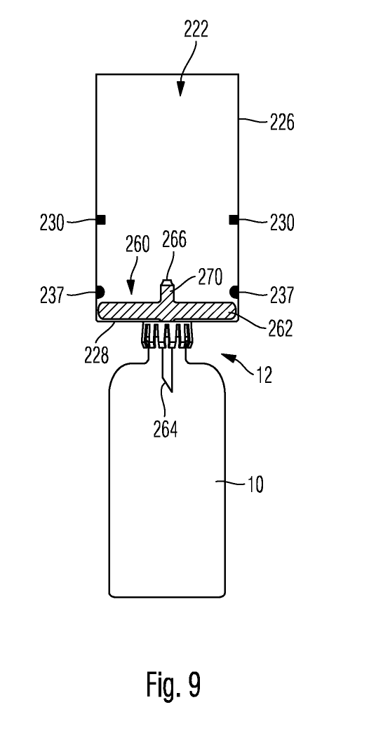

In the third embodiment as illustrated in FIGS. 7 to 9, unless otherwise described, again similar or identical components compared to the embodiment as shown in FIGS. 1 to 3 are denoted with the same reference numerals increased by 200.

Also here, the extraction device 201 comprises a housing 220 to non-releasably engage with the container 10 comprising a liquid medicament. Similar and as already explained with respect to the embodiment according to FIGS. 1 to 3, there is provided at least one fixing member 237 at the inside of a sidewall 226 in close proximity to a bottom wall 228 of the housing 220. In the embodiment according to FIGS. 7 to 9, the piercing member 260 is preferably integrally formed with the syringe or drug delivery device 250 and can be separated therefrom by means of a predetermined breaking structure 266. Moreover, the syringe 250 comprises a barrel 254 and two mutually corresponding connectors 256, 258. Downstream of the distal connector 258 there is located the predetermined breaking structure 266 that provides a well-defined separation of the syringe 250 and the piercing member 260.

Similar as already explained with respect to FIGS. 1 to 3, the syringe 250 and the piercing member 260 can be urged in distal direction until the piercing member 260 reaches a distal stop position as shown in FIG. 8. In this position, the at least one, preferably several circumferentially distributed fixing members 237 serve to keep the piercing member 260 in this distal position, in which the radially extending flange portion 262 of the piercing member 260 abuts with the bottom wall 228 of the housing 220. Here, it is of particular benefit when the piercing member 260 can still rotate relative to the housing 220.

This way, a screwed interconnection of the two connectors 256, 258 cannot be released by screwing or rotating the barrel 254 of the syringe 250 relative to the housing 220 of the extraction device 201. Instead, the predetermined breaking structure 266 between the piercing member 260 and the drug delivery device 250 is designed to break and to separate when a predetermined proximally directed force is applied to the drug delivery device 250 relative to the housing 220. This way, a syringe 250 to be filled with the medicament in a configuration according to FIG. 8 can be non-reversibly disconnected from the piercing member 260 that features a proximal conduit 270 or shaft portion which does not allow for re-connecting the piercing member 260 with a syringe 250.

When the syringe 250 is withdrawn from the housing 220 and its receptacle 222 it comprises two mutually engaging connectors 256, 258. When these connectors 256, 258 are of LUER-locked type, for instance, by way of unscrewing female connector 258 from a male connector 256, the syringe 250 with its remaining male connector 256 can be universally coupled to corresponding injection devices, such like infusion tubes or injection needles featuring a corresponding female connector.

Optionally and as shown in FIGS. 7 to 9, the housing 220 may comprise an additional set of radially inwardly extending fixing members 230 located at a predetermined axial distance in proximal direction 3 from the fixing members 237. Those second fixing members 230 may be useful in embodiments, wherein the piercing member 260 and/or the syringe 250 are pre-assembled inside the housing 220 of the extraction device. The fixing members 230 effectively prevent removal of the piercing member 260 from the housing 220 at all.

Moreover, a pre-assembly of the drug delivery device 250 to the extraction device 201 as illustrated in FIGS. 7 to 9 may be also implemented with the embodiments as shown in FIGS. 1 to 6. Then, the drug delivery device 50, 150 could be pre-connected with the piercing member 60, 160 by means of a predetermined breaking structure. The fixing members 37 as illustrated in FIGS. 1 and 2 would then correspond to the fixing members 230 as shown in FIGS. 7 to 9. In effect, the drug delivery device 50, 150, 250 could be designed and configured as an integral or releasable part of the extraction device 1, 101, 201, respectively.

Generally, in all embodiments illustrated in FIGS. 1 to 9 the extraction device 1, 101, 201 may either be provided as a separate piece or may be already pre-assembled with the container 10 in a non-releasable way when released to the market. In this case, an end user is obliged to make use of the extraction device 1, 101, 201 for filling of a drug delivery device, such like a syringe 50, 150, 250.

Moreover, also the piercing member 60, 160, 260 may be pre-assembled inside the extraction device 1, 101, 201 upon delivery to an end user. Such a configuration might be of particular benefit for the embodiment according to FIGS. 1 to 3. By having the piercing members 60 pre-assembled inside the housing 20, the separate annular fixing member 34 is generally no longer needed and can be effectively substituted by the flange portion 62 of the piercing member 60.

Independent on whether the extraction device 1, 101, 201 is pre-assembled with the container 10 and independent on whether the piercing member 60, 160, 260 is pre-assembled in the housing 20, 120, 220 of said extraction device 1, 101, 201, the drug delivery device, 50, 150, 250 may be pre-assembled with the piercing member 60, 160, 260 and may be delivered to the end user as a syringe- and piercing member kit.

The various pre-assemblies as explained above provide different stages to oblige the end user to extract the medicament from the container 10 only once.

1-15. (canceled)

16. An extraction device for one-time extracting a medicament from a container, the extraction device comprising:
a housing adapted to non-releasably engage with the container and comprising an axially elongated receptacle,
wherein the receptacle is adapted to axially guide a drug delivery device and a piercing member to a distal stop position for penetrating a seal of the container, and further comprising
at least one fixing member to keep the piercing member in the distal stop position and to support a non-reversible disconnection of the drug delivery device from the piercing member.

17. The extraction device according to claim 16, wherein the fixing member radially inwardly protrudes from an inner side wall of the receptacle.

18. The extraction device claim 16, wherein the receptacle comprises a bottom wall at its distal end providing a distal abutment face for the piercing member, wherein the bottom wall further comprises a through opening to receive a neck portion of the container and/or to receive a piercing element of the piercing member.

19. The extraction device according to claim 18, further comprising a tubular shaped fastening member protruding from the bottom wall in distal direction to receive the neck portion of the container, wherein the fastening member comprises at least one interlock member to frictionally and/or to positively engage with the neck portion in a non-releasable way.

20. The extraction device according to claim 16, further comprising at least one reuse preventer to inhibit re-establishment of a fluid-transferring connection between the drug delivery device and the piercing member once the drug delivery device has been removed from the receptacle.

21. The extraction device according to claim 20, wherein the reuse preventer comprises at least one bendable and/or pivotable flap portion attached to an inner side wall of the receptacle and being transferable into a reuse preventing configuration in which the flap portion radially extends across the inner diameter of the receptacle.

22. The extraction device according to claim 20, further comprising at least two reuse preventers comprising at least two flap portions regularly arranged along the inner circumference of the receptacle.

23. The extraction device according to claim 21, wherein the at least one flap portion is pre-tensioned radially inwardly and is held against the inner side wall in an initial configuration by means of an annular fixing member being slidably displaceable in distal direction with respect to the receptacle by means of the piercing member.

24. The extraction device according to claim 23, wherein the bottom wall comprises an annular recess to receive the annular fixing member.

25. The extraction device according to claim 23, wherein the reuse preventer is of L-shaped geometry and comprises at least one radially inwardly extending flap portion at a distal end to engage with the piercing member upon insertion thereof into the receptacle thereby inducing a radially inwardly directed torque to a proximally located and axially extending flap portion integrally formed with the radially inwardly extending flap portion.

26. The extraction device according to claim 16, wherein the at least one radially inwardly extending flap portion serves as the fixing member to frictionally engage with the piercing member.

27. An extraction kit for one-time extracting a medicament from a container, the kit comprising:
an extraction device according to claim 16,
a piercing member slidably insertable into the receptacle of the extraction device and comprising a piercing element to pierce a seal of the container non-releasably engagable with the extraction device, and
a drug delivery device to releasably interconnect with a proximal portion of the piercing member.

28. The extraction kit according to claim 27, wherein the piercing member comprises a radially extending flange portion to interact with the at least one radially inwardly extending fixing member of the extraction device.

29. The extraction kit according to claim 27, wherein the piercing member is pre-assembled with the drug delivery device and wherein the piercing member and the drug delivery device are disconnectable by means of a fluid-transferring connector and/or by means of a predetermined breaking structure.

30. The extraction kit according to claim 27, further comprising a container at least partially filled with the medicament and being at least pre-assembled with the extraction device in a non-releasable way.
